(19) United States
(12) Patent Application Publication
(10) Pub. No.: US 2012/0124125 A1
(43) Pub. Date: May 17, 2012

(54) AUTOMATIC JOURNAL CREATION

(75) Inventors: Merlin J. Smith, Chandler, AZ (US); Kungwel Liu, Chandler, AZ (US); Susan S. Chen, Chandler, AZ (US); Bernhard P. Weisshaar, Phoenix, AZ (US); Haitao Huang, Chandler, AZ (US)

(73) Assignee: GARMIN SWITZERLAND GMBH, Schaffhausen (CH)

(21) Appl. No.: 12/947,554

(22) Filed: Nov. 16, 2010

(51) Int. Cl. G06F 15/16

(52) U.S. Cl. 709/203

(57) ABSTRACT

Techniques are described that facilitate the automatic creation of journals that may include a variety of related content. Journal creation functionality may be furnished by a server to one or more client devices to create journals of content that include content from one or more content sources. The content provided by the content sources includes tags (e.g., metadata) describing the content. Thus, a client device may furnish a request to a server to create a journal of content. The request includes an attribute to relate the content of the journal. The server causes content to be associated with the journal from one or more computer-readable content sources accessible by the server by associating one or more of the content tags with the attribute for one or more existing journals and thereafter creating the journal using the processor by causing content from the one or more existing journals to be associated with the journal, the associated content having tags associated with the attribute.

### BACKGROUND

Portable electronic devices such as mobile phones (e.g., smart phones, cellular telephones, etc.), personal navigation devices (PNDs), and so forth can be used to access an ever increasing variety of content. For example, portable electronic devices may be equipped to acquire content such as audio files, photograph files, video files, e-mails, navigation information, short message service (SMS) communications, multimedia messaging service (MMS) communications, voice mail, voice memos, weather, map data, saved routes, text files, data files, and so on. Additionally, portable electronic devices may be used to access content such as video, audio, navigation information, news, blogs, and so on, from a variety of remote sources over a wired or wireless network.

Various software applications are employed by portable electronic devices to access different types of content and present the content to the user of the device. For example, a messaging application may be employed by a portable electronic device to send and receive SMS and/or MMS text messages, a browser application may be employed by the device to access video and audio content, and so on. Typically, such applications also manage access and storage of the content available on the portable electronic device. Thus, content accessed by the device is typically stored and presented with content of the same type.

### SUMMARY

Techniques are described that facilitate the automatic creation of journals that may include a variety of related content. In one or more implementations, journal creation functionality may be furnished by a server to one or more client devices to create journals of content that include content from one or more content sources. The content provided by the content sources includes tags (e.g., metadata) describing the content. Thus, a client device may furnish a request to a server to create a journal of content. The request includes an attribute to relate the content of the journal. The server causes content to be associated with the journal from one or more computer-readable content sources accessible by the server by associating one or more of the content tags with the attribute for one or more existing journals and thereafter creating the journal using the processor by causing content from the one or more existing journals to be associated with the journal, the associated content having tags associated with the attribute.

In one or more implementations, the server may cause content to be associated with the journal from one or more computer-readable content sources accessible by the server by finding content that contains the attribute and associating the content with a journal. In one or more implementations, the server may cause content to be associated with the journal by associating one or more of the content tags with the attribute and/or finding content that contains the attribute.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that includes a server operable to furnish journal creation functionality to one or more client devices.

FIG. 2 is a Venn diagram illustrating an intersection of two existing journals.

FIG. 3 is a flow diagram depicting a procedure in an example implementation in which a client device furnishes a request to create a journal to a server.

FIG. 4 is a flow diagram depicting a procedure in an example implementation in which a request to create a journal is furnished to the server from a client device.

FIG. 5 is a block diagram illustrating an example process of creating a journal in response to a request for a new journal.

FIG. 6 is a Venn diagram illustrating two example existing journals that do not intersect.

FIG. 7 is a Venn diagram illustrating an example procedure to create a requested journal using content from two existing journals that do not intersect.

### DETAILED DESCRIPTION

### Overview

Content may be stored within the journal and/or accessible via links. In one or more implementations, the server may continue associating content having the associated attribute after the initial journal creation. The client device may furnish a request to a server to create a journal. It is to be understood that while one or more implementations described herein illustrate the client device as the source of the request, the request may originate from a web client, application, plug-in, and other systems external to the client device that may be used to create and send a request. The request may identify an attribute that is to be used to associate the content of the requested journal. The server may search accessible content sources for content that may be of interest to the user who requested the journal. The content sources may be remote data sources, content stored on the server or client devices, or separate storage drives. The server may select content for the requested journal from one or more content sources that are accessible by the server by identifying content stored in the content sources with the identified attribute. The server creating the journal may then complete the creation of the requested journal by associating the selected content with the requested journal. The completed journal may be returned to the user's client device, stored on the server, or remotely at a content source. The content that is available for searching and selecting at the content sources may include one or more data tags (e.g., metadata) containing searchable information that may be useful for describing the stored content. Information that may be contained in the tags includes any information that may have been associated automatically or manually by another user. Available information may include, but is not limited to, notes, names, location information, date, time, communications, etc.

Electronic data tags are a type of meta-information that describe some aspect of content to which they are associated with. The use of tags has gained wide popularity due to the growth of social networking, photography sharing, search engines, and bookmarking websites. These websites allow users to create and manage tags that categorize content using simple keywords. Increasingly, tags may include more information than traditional non-hierarchical keywords or terms. For example, tags may provide information about the associated content in the form of descriptions, categorizations, classifications, semantics, comments, notes, annotations, hyperlinks, or references. Tags may be combined into tag profiles that reference the content resources that reside in distributed, and often heterogeneous, storage repositories. The content provided by content sources may include one or more tags (e.g., metadata) describing the content.

Accordingly, techniques are described that facilitate the automatic creation of journals that may include a variety of tagged content that is related by one or more shared attributes. As used herein, a journal may be viewed as an organized collection of tagged content that shares one or more attributes. For example, a journal may be comprised of a collection of content files, which may have a variety of formats, that are associated together according to one or more attributes that link the files in some manner. Various types of client devices (e.g., mobile phones, smart phones, personal navigation devices, tablet computers, athletic training devices, cameras, and so on) can create different types of content. Journals can be created using any and/or all of this diverse content.

Tagged content suitable for inclusion in a journal may be referred to herein as a “journalable.” A journal may thus include a variety of tagged content (or journalables) including, but not limited to: photographic files, audio files, video files, text files, data files, emails, short message service (SMS), multimedia messaging service (MMS), communications, voice mail, phone calls, voice memos, weather, map data, and so on; device-generated content such as navigation information including geo-coordinates, geographical data, maps, calculated routes, saved routes, departure times, arrival times, waypoints visited, elapsed time at locations, point of interest (POI) searches conducted, vehicle information (speed, direction, etc.), OBD-II data from a vehicle interface, biometric and cardiovascular information, and so on; external content such as news, weather, ambient information such as background music, and so on; media content such as the identification (e.g., title and artist) of music was being played, the identification (e.g., title and artist) of videos that were watched, what web sites were accessed, what web content was posted; related-device content such as nearby devices/computer networks, paired devices (e.g., a camera), data that is shared with nearby devices, and so on; augmented related content to enable AR functionality during playback; extensible content (e.g., the techniques may be extensible, for example, by allowing users to register new content).

The tagged content may be associated with the journal in a variety of ways. In one or more implementations, the content may be stored as part of the journal. In one or more implementations, the content may be stored separately from the journal and internally referenced by the journal. For instance, the journal may use links to the content as internal references.

In one or more implementations, the techniques described may be implemented in a server/client system environment. In such implementations, functionality may be furnished by a server to one or more client devices to create journals that associate content selected from one or more content sources. In one or more implementations, the server may be a collection of server computers operating independently or collectively.

When a journal is to be created, a client device furnishes a request to the server to cause the server to generate the journal. The request may identify one or more attributes to be used to associate the content that will be part of the journal to be created by the server. The server may then select content from one or more content sources accessible by the server to be included in the journal after searching the content sources for suitable content. In implementations, the content is selected by first identifying content tags that at least partially match, or relate to but do not at least partially match, the attribute requirements that were identified in the request to ascertain which content tags should be used in selection of content for association with the journal. Thereafter, the server selects the content having the selected tags. The server may then create one or more journals and associate the selected content with the journal. Thus, searches of tagged content may be stored in an organized manner as a journal instead of as singular, unrelated search results.

In the following discussion, an example environment is first described that is operable to perform the techniques to select content associated with one or more attributes of a request and cause the selected content to be associated with a journal. Exemplary procedures are then described that may be employed in the exemplary environment, as well as in other environments without departing from the spirit and scope thereof.

Example Environment

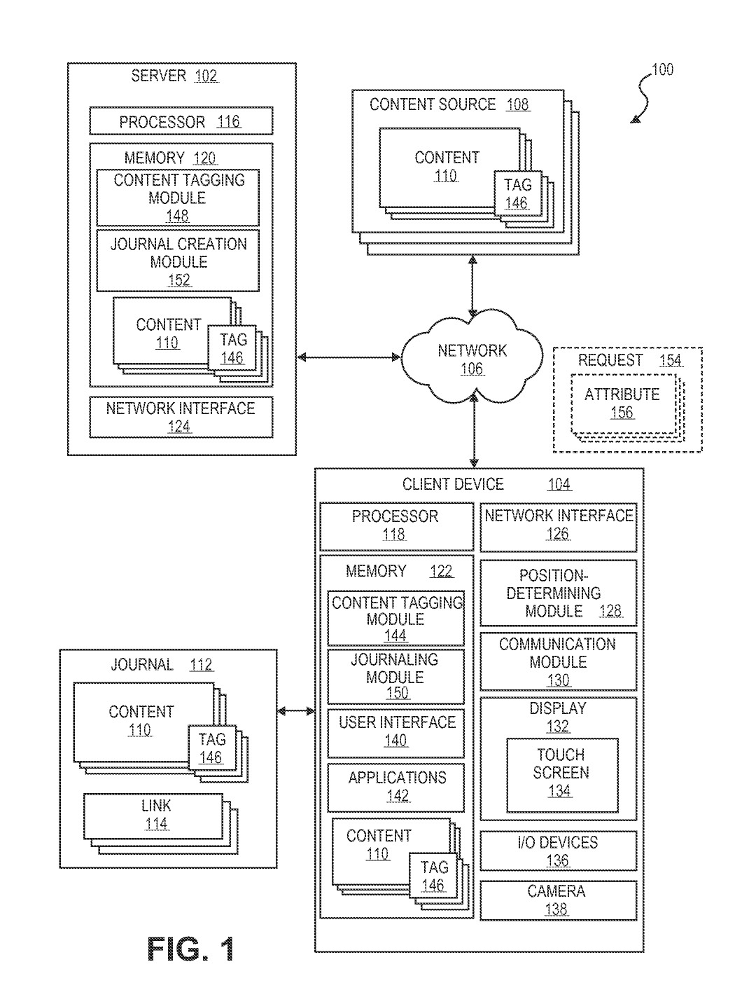

FIG. 1 illustrates an environment 100 in an example implementation that is operable to facilitate the automatic creation of journals in accordance with the present disclosure. The illustrated environment 100 includes a server 102 and a client device 104 that communicates with the server 102 via one or more networks 106. The server 102 may access one or more content sources 108 that include tagged content 110 that may be included in the journals 112 and accessed by the client device 104. The journals 112 may be configured to present a wide variety of content 110 and/or links 114 to content 110 in an organized manner to furnish a rich content access experience to the user of the client device 104.

The server 102 may be configured in a variety of ways. For example, the server 102 may be configured as one or more server computers that are capable of communicating over a network 106. In one implementation, the server 102 may be a server computer configured to furnish journal 112 with creation, storage, manipulation, and/or editing functionality that is accessible by one or more clients such as client device 104 as generally described hereinbelow.

The client device 104 may also be configured in a variety of ways. For example, the client device 104 may be configured as a location-aware device such as a navigation device, a mobile phone (e.g., a smart phone, a cell phone, etc.), a portable media player, a mobile internet device, a portable computing device, and so forth that is capable of communicating over network 106. The client device 104 may also be configured as a computer such as a desktop or laptop computer that is capable of communicating over network 106. Thus, the client device 104 may range from a full resource device with substantial memory and processor resources (e.g., a personal computer) to low resource devices with limited memory and/or processing resources (e.g., a cell phone). Additionally, although one client device 104 is illustrated, it is to be understood that server 102 may provide the functionality described herein to multiple client devices 104.

The network 106 may assume a wide variety of configurations. The network 106 is representative of a variety of different types of networks and connections that are contemplated including, but not limited to, wired and wireless networks. Examples of wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth. In some implementations, the network 106 may include a wide-area cellular telephone network, such as a 3G cellular network, a satellite network, mobile data network, the Internet, a wide area network (WAN), a local area network (LAN), a public telephone network, an extranet, an intranet, and so on. In an implementation, the network 106 may comprise a single network (e.g., a single wide-area cellular telephone network). In other implementations, the network 106 may comprise multiple networks (e.g., a wide-area cellular telephone network and the Internet) that facilitate communication between the server 102 and the client device 104.

The network 106 may be representative of a variety of different communication pathways and network connections that may be employed, individually or in combinations, to communicate among the components of the environment 100. Thus, the network 106 may be representative of communication pathways achieved using a single network or multiple networks.

In FIG. 1, the server 102 and the client device 104 are illustrated as including a respective processor 116 or 118; a respective memory 120 or 122; and a respective network interface 124 or 126. In the following discussion, elements of the server 102 are described with reference to FIG. 1. Respective elements and/or reference numbers related to the client device 104 are shown in parentheses. Where appropriate, elements of the client device 104 are described separately.

The processor 116 (118) provides processing functionality for the server 102 (client device 104) and may include any number of processors, micro-controllers, or other processing systems and resident or external memory for storing data and other information accessed or generated by the server 102 (client device 104). The processor 116 (118) may execute one or more software programs that implement techniques described herein. The processor 116 (118) is not limited by the materials from which it is formed or the processing mechanisms employed therein and, as such, may be implemented via semiconductor(s) and/or transistors (e.g., electronic integrated circuits (ICs)), and so forth.

The memory 120 (122) is an example of tangible computer-readable media that provides storage functionality to store various data associated with the operation of the server 102 (client device 104), such as the software program and executable program segments mentioned above, or other data to instruct the processor 116 (118) and other elements of the server 102 (client device 104) to perform the steps described herein. Although a single memory 120 (122) is shown, a wide variety of types and combinations of memory may be employed. The memory 120 (122) may be integral with the processor 116 (118), stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In implementations of the client device 104, the memory 122 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

The network interface 124 (126) provides functionality to enable the server 102 (client device 104) to communicate with one or more networks (depicted in FIG. 1 as network 106). In various implementations, the network interface 124 (126) may include a variety of components such as modems, routers, wireless access points, cellular telephone transceivers, and so forth, and any associated software employed by these components (e.g., drivers, configuration software, and so on). In some implementations, the network interface 124 (126) may be an internal component of the server 102 (client device 104). However, in other implementations, one or more components of the network interface 124 (126) may be external components communicatively coupled to the server 102 (client device 104) via a wired or wireless connection.

The client device 104 may further include a position-determining module 128 configured to provide location-determining functionality for the client device 104. Location-determining functionality, for purposes of the following discussion, may relate to a variety of different navigation techniques and other techniques that may be supported by “knowing” one or more locations. For instance, location-determining functionality may be employed to provide location data, timing data, speed data, and a variety of other navigation-related data.

In implementations, the position-determining module 128 may comprise a receiver that is configured to receive signals from one or more position-transmitting sources. For example, the position-determining module 128 may be configured for use with a Global Navigation Satellite system (GNSS), such as Global Positioning System (GPS), Global Orbiting Navigation Satellite System (GLONASS), Galileo positioning system, or the Compass navigation system. In some implementations, the position-determining module 128 may comprise a GPS receiver operable to receive navigational signals from GPS satellites used to determine the location of the client device 104 as a function of the signals.

While a GPS system is described in this document, it is contemplated that a wide variety of other positioning systems may also be used, such as terrestrial based systems (e.g., wireless-telephony systems or data systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros or odometers), and so on.

The client device 104 may be configured to perform a variety of navigation related functions. For example, the client device 104 may be configured for vehicle navigation, aerial navigation (e.g., for aircraft, helicopters, and so on), marine navigation, personal use (e.g., a mobile device or fitness-related equipment), and so forth. Accordingly, the client device 104 may include multiple position-determining modules 128 to determine the location of the device 104 using a variety of the techniques as described above.

The client device 104 may also include a communication module 130 representative of communication functionality to permit client device 104 to send/receive data between different devices (e.g., components/peripherals) and/or over the network 106. Communication module 130 may be representative of a variety of communication components and functionality including, but not limited to: one or more antennas; a browser; a transmitter and/or receiver; a wireless radio; data ports; software interfaces and drivers; networking interfaces; data processing components; and so forth.

The client device 104, through functionality represented by the communication module 130, may be configured to communicate via one or more networks 106 with a cellular provider and an Internet provider to receive mobile phone service and Internet content, respectively.

The client device 104 includes a display 132 to display information to a user of the mobile electronic device 104. In some implementations, the display 132 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display 132 may be backlit via a backlight such that it may be viewed in the dark or other low-light environments. In some implementations, the display 132 may not be integrated into the client device 104 and may instead be connected externally using wireless or wired communication, such as universal serial bus (USB), Ethernet, serial connections, and so forth.

The display 132 may be provided with a touch screen 134 for user input of data and commands. For example, a user may operate the client device 104 by touching the touch screen 134 and/or by performing gestures on the screen 134. In some implementations, the touch screen 134 may be a capacitive touch screen, a resistive touch screen, an infrared touch screen, combinations thereof, and the like.

The client device 104 may further include one or more input/output (I/O) devices 136 (e.g., a keypad, buttons, a wireless input device, a thumbwheel input device, mouse, a trackstick input device, and so on). The I/O devices 136 may include one or more audio I/O devices, such as a microphone, speakers, and so on.

The client device 104 may contain an integrated camera 138 that is configured to capture image content such as still photographs and/or video by digitally recording images using an electronic image sensor or other image capturing hardware. In some implementations, captured image content may be stored as digital image files in memory 122. The digital image files may be stored in a variety of file formats. For example, digital still photographs may be stored using a Joint Photography Experts Group standard (JPEG) file format, Tagged Image File Format (TIFF), Raw data formats, and so on. Digital video may be stored using a Motion Picture Experts Group (MPEG) file format, an Audio Video Interleave (AVI) file format, a Digital Video (DV) file format, a Windows Media Video (WMV) format, and so forth. Exchangeable image file format (Exif) data may be included with digital image files to provide metadata about the image media. For example, Exif data may provide information regarding the date and time the image content was captured, the location where the content was captured, and the like. Digital image content may be displayed by display 132 and/or transmitted to other devices via the one or more networks 106 (e.g., via an email or MMS text message).

The client device 104 may include a user interface module 140, which provides functionality to control the display of information and data to the user of the client device 104 via the display 132. The user interface module comprises computer readable executable program that is storable in memory 122 and executable by the processor 118.

The client device may include an application module 142 that is comprised of computer readable executable program, which is storable in memory 122 and executable by the processor 118, to perform a specific operation or group of operations to furnish functionality to the client device 104. The application module 142 may include an executable program such as cellular telephone application, instant messaging application, email client application, photograph sharing application, calendar application, address book application, and so forth. In some implementations, the application module 142 may include one or more stand-alone applications operable for execution by the processor 118.

In some implementations, the user interface module 140 may provide functionality to allow the user to interact with the application module 142 of the client device 104 by providing interaction with the touch screen 134 and/or the I/O devices 136. For example, the user interface module 140 may cause an application programming interface (API) to be generated to expose functionality to provide the user interaction with the application module 142, where the user interface is outputted to the display 132 and user input is received via the touch screen 134 and/or the I/O devices 136.

The client device 104 may further include a content tagging module 144, which may be implemented as a computer readable executable program stored in memory 122 and executed by the processor 118. The content tagging module 144 is representative of content tagging functionality that is provided by the client device 104. The content tagging functionality allows the client device 104 to generate and/or assign one or more tags 146 to content 110 created and/or accessed by the client device 104. Similarly, the server 102 may also be provided with a content tagging module 148, which may be implemented as a computer readable executable program stored in memory 120 and executed by the processor 116. The content tagging module 148 of the server 102 is representative of content tagging functionality that may be provided by the server 102, either alone, or in combination with the content tagging functionality provided by the content tagging module 144 of the client device 104. In implementations, the tags 146 assigned by the content tagging module 148 (144) may comprise meta-information (e.g., metadata) that provides some information regarding the content, which may be used to categorize the tagged content 110. The tags 146 may capture information regarding the tagged content 110 in the form of descriptions, categorizations, classifications, semantics, comments, notes, annotations, hyperlinks, references, and so on.

Tagged content 110 may be stored in a variety of locations. As shown in FIG. 1, tagged content 110 may be stored in one or more content sources 108. The content sources 108 must be accessible to server 102. In some implementations, the content sources 108 are accessible by the server 102 and/or client device 104 through the network 106. As shown in FIG. 1, tagged content 110 may also be stored in the memory 120 (122) of the server 102 and/or the client device 104. Thus, the server 102 and/or the client device 104 may themselves serve as content sources 108 for server 102. In some implementations, the content sources 108 may include content 110 stored on a separate storage device to which the server 102 and/or client device 104 have access without the use of network 106. Tagged content 110 may comprise any content that may be associated with (e.g., stored in, linked by, etc.) one or more existing journal(s) 112 on one or more client devices 104.

In one or more implementations, either or both of the content tagging modules 148 (144) may cause content 110 to be tagged with a geospatial tag (e.g., a tag 146) that includes geo-referenced location information (e.g., latitude, longitude, and/or altitude) and/or a temporal tag (e.g., a tag 146) that includes date, day, and/or time information. Thus, a geospatial tag 146 may provide a location (e.g., latitude/longitude coordinates) to the tagged content 110. Similarly, a temporal tag 146 may provide a time value (e.g., the time the content 110 was created) to the tagged content 110.

The content tagging modules 148 (144) may be configured to furnish content tagging functionality in response to a user request. Thus, the user may enter a tag to be applied to tagged or untagged content 110 manually using the display 132, touch screen 134, and/or an I/O device 136 such as a keypad, microphone, and so on. In implementations, the content tagging module 148 (144) may cause the user of the client device 104 to be prompted to enter text for a tag to be applied to content 110 acquired by the client device 104. Thus, for example, the content tagging module 144 of a client device 104 may cause a prompt to be displayed by the display 132 to facilitate tagging of a still photograph captured by the camera 138. Other examples are possible.

The content tagging modules 148 (144) may also be configured to furnish automatic content tagging functionality. Thus, content 110 accessed by the client device 104 may be tagged with one or more tags 146 without user intervention. For example, the content tagging module 144 of a client device 104 may automatically tag content 110 accessed (e.g., received, acquired, recorded, etc.) by the client device 104 with a geospatial tag and/or temporal tags 146 to indicate the location of the client device 104 when the content 110 was accessed and/or the time that the content 110 was accessed by the client device 104. Moreover, the content tagging modules 148 (144) may be configured to automatically tag content 110 with tags 146 that may be appropriate for the content 110. For example, the content tagging module 144 of the client device 104 may automatically tag a photograph captured by the camera 138 that is taken near a certain location (e.g., “Grandma” or “Disneyland”) with a tag 146 derived from the location's title (e.g., “Grandma” or “Disneyland”). To automatically tag content with information associated with nearby locations, the client device 104 may determine its current location using the position-determining module 128, access map data stored within the memory 122, and identify points of interest (POIs) that relate to the determined current location. Similarly, the content tagging module 148 of the server 102 may automatically tag an email sent from the client device 104 with terms derived from the subject of the email, the name or email address of the sender, and/or the name or email address of the recipients.

Tags 146 for content 110 may be based on tags 146 previously applied to content 110 by the content tagging modules 148 (144). For example, the content tagging module 144 of the client device 104 may be configured to automatically generate tag 146 for content 110 acquired at a georeferenced location based on a tag 146 provided to content 110 previously acquired at or near the georeferenced location. Thus, in an example, the content tagging module 144 of the client device may automatically tag a still photograph taken at a georeferenced location with the tag “swimming” because the user of the client device 104 has previously caused the content tagging module 144 to manually tag a still photograph taken at a prior time at or near the location with the tag 146 “swimming”.

The content tagging modules 148 (144) may create tags 146 based on previous entries in email, text messages, contacts, calendars, and so on. Further, it is contemplated that multiple tags 146 may be generated automatically for a given content file. In this manner, the content tagging modules 148 (144) may automatically generate dynamic tag sets for selection by the user. Tags 146 within such tag sets may be based on location (e.g., georeferenced coordinates, POI proximity, etc.), time, events, cross-references from other content, journals, journalables and users, and so on.

In one or more implementations, the content tagging modules 148 (144) may assign a confidence level to tags 146 applied to content 110. For example, the content tagging module 144 may assign a high confidence level to a tag 146 manually entered by a user of the client device 104. Thus, a tag 146 entered by the user to tag a photograph (e.g., “Grandma”) may be given a higher confidence level than a tag 146 automatically generated for a photograph by the content tagging module 144 of the client device 104 based on proximity to a POI (e.g., “Grandma”) when the photograph was taken, which, in turn, may be given a higher confidence level than a tag 146 applied to a photograph by the content tagging module 148 of the sever 102 at a later time. Confidence levels may be applied in a variety of formats. For example, confidence levels may comprise discrete confidence descriptions (e.g., “High,” “Medium,” and “Low”), a numeric rating (e.g., a rating of “1” for lowest confidence to “10” for highest confidence), and so on.

The client device 104 may further include a journaling module 150, which may be implemented as a computer readable executable program stored in memory 122 and executed by the processor 118. The journaling module 150 is representative of functionality implemented in the client device 104 that facilitates the creation of a journal 112. In some implementations, the journaling module 150 may create journals 112 automatically. The journaling module 150 may, for example, facilitate the creation of journals 112 that include content 110 selected from the content 110 resident within the memory 122 of the client device 104. This content 110 may be created by the client device 104 (e.g., photographs, POIs, text files, etc.) and/or received by the client device 104 via the network 106 (e.g., emails, SMS messages, MMS messages, etc.).

The journaling module 150 may also generate a journal 112 automatically with minimal or no user intervention. For example, the journaling module 150 may automatically generate a journal 112 for an event (e.g., a baseball game, a wedding, a business meeting, etc.) when the user attends the event or automatically generate a journal for a specific location when the client device 104 is determined to be at or near the location. A variety of other examples are possible.

The journaling module 150 of the client device 104 may communicate with the server 102 via the network 106 (e.g., via network interface 126) to facilitate the creation of journals 112 that include content 110 or links 114 to content 110 selected from a variety of content sources 108. Thus, as shown in FIG. 1, the server 102 may further include a journal creation module 152, which may be implemented as a computer readable executable program stored in memory 120 and executed by the processor 116 of the server 102. The journal creation module 152 is representative of functionality implemented on the server 102 that facilitates the creation of journals 112 that include content 110 selected from one or more content sources 108. In some implementations, the journal creation module 152 may facilitate the creation of journals 112 automatically.

When a journal 112 is to be created, the journaling module 150 of the client device 104 generates a request 154 that includes one or more attributes 156 selected to relate the content 110 that will be part of the requested journal 112. For instance, the journaling module 150 may cause the user interface module 140 to furnish a prompt to the user of the client device 104 via the display 132 to allow the user to identify or select the one or more attributes 156 to relate the content 110 of the journal 112 via the touch screen 134, an I/O device such as a keypad or a microphone, and so on. A variety of attributes 156 may be identified. For example, the user may identify or select a text search string (e.g., a name, an event, a place, etc.), geo-coordinates (e.g., latitude, longitude, and/or altitude) derived from the position determining module 128, a calendar item, a text message (e.g., an SMS or MMS message), an email, and so on. The identified attributes 156 are then included in the request 154. The journaling module 150 may then cause network interface 126 to transmit the generated request 154 via the network 106 to the server 102 where it is received by the server 102 using the network interface 124. The journal creation module 152 may then generate the requested journal 112 in response to the request 154. More specifically, the journal creation module 152 may search for and select content 110 for the journal 112 from various content sources 108 accessible by the server 102.

In some implementations, a web client may be used to send the request 154 identifying one or more attributes 156 and one or more client devices 104 to receive or create the requested journal 112. For instance, a third party may use a web client to send the request 154 to the server 102 or the journaling module 150 of one or more client devices 104. The request 154 may be sent to the journaling module 150 instead of the server 102 if the journal 112 will be created by the client device 104 without assistance from the server 102.

In some implementations, content 110 may have a tag 146 associated with the content 110. The journal creation module 152 may utilize the tag to select content 110 for the requested journal 112 by first associating content tags 146 with one or more attributes 156 to ascertain the appropriate tags 146 to be used in selection of content 110 for inclusion with the journal 112. The journal creation module 152 may, for instance, select tags 146 that at least partially match one or more of the attributes 156 in the request 154 received from the client device 104. Thus, in an example, the journal creation module 152 may select the tags “Grandma” and “Grandma's House” as being associated with the attribute 156 “Grandma” in a request 154. The journal creation module 152 may further identify tags 146 that do not at least partially match an attribute 156 of the request 154, but which are related to an attribute 156 in some manner. Thus, in an example, the journal creation module 152 may select geospatial tags 146 comprised of a latitude, longitude, and/or altitude that at least approximately match the location of the home of the grandmother of the user of the client device 104 as being associated with the attribute 156 “Grandma” described above. Similarly, in another example, the journal creation module 152 may select the tag 146 “Smith family reunion” as being associated with the attribute 156 “Grandma” of the request 154. A variety of other examples are possible.

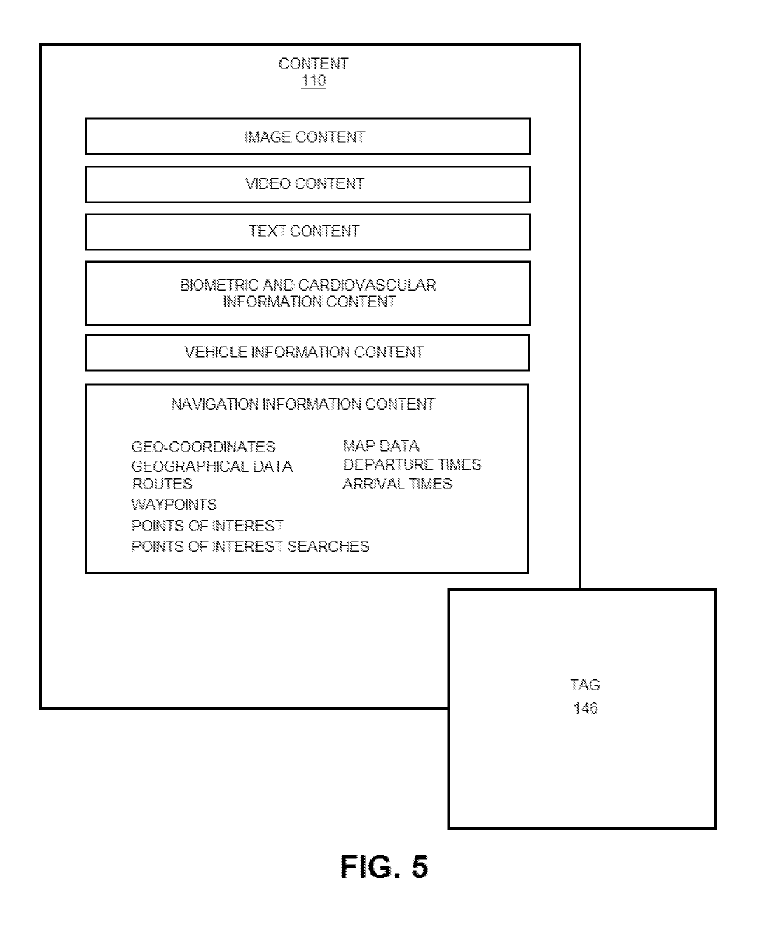

In one or more implementations, the journal creation module 152 may select content 110 for the requested journal 112 by associating content elements and/or tags 146 that reference one or more attributes 156 to be used for inclusion within the journal 112. For instance, as illustrated in FIG. 5, content elements may comprise searchable image content, video content, text content, navigation information content, combinations thereof, and the like. The journal creation module 152 may find complete matches, partial matches, and relationships to attribute 156 for all types and formats of content elements that may be contained within content 110. The journal creation module 152 may, for instance, select content elements that at least partially match one or more of the attributes 156 in the request 154 received from the client device 104. In an example, the journal creation module 152 may select text, images, video, and navigation information content that use or include the words “Grandma” and “Grandma's House” as being associated with the attribute 156 “Grandma” in a request 154. Thus, the journal creation module 152 may select content 110 for the requested journal 112 based on the content elements within the content 110 and without requiring reference to the tags 146 associated with the content 110.

The journal creation module 152 may further identify content elements that do not at least partially match an attribute 156 of the request 154, but which are related to an attribute 156 in some manner. Thus, in an example, the journal creation module 152 may select content 110 comprised of content elements like latitude, longitude, and/or altitude that at least approximately match the specified attribute 156—e.g., the location of the home of the grandmother of the user of the client device 104 as described in the above. Similarly, in another example, the journal creation module 152 may select content 110 comprised of a content element of “Smith family reunion” as being associated with the attribute 156 “Grandma” of the request 154. A variety of other examples are possible for selecting content based on its content elements. For instance, both tags 146 and content elements may be utilized to select content 110 for included in the requested journal 112.

In some implementations, content 110 may not have a tag 146 associated with the content 110. When a tag is not associated with the content 110, the journal creation module 152 may select content 110 for the requested journal 112 by associating content elements with one or more attributes 156 to ascertain the appropriate content 110 to be used for inclusion within the journal 112.

The journal creation module 152 may then select content 110 from the various content sources 108, which may include the server 102, the client device 104, other client devices 104, content 110 stored on separate storage devices to which the server 102 and/or client device 104 have access without the use of network 106, and so on, that include the selected tags 146 (i.e., the tags 146 associated with the one or more attributes 156 of the request 154). For instance, in the examples discussed above, the journal creation module 152 having selected the tags 146 “Grandma,” “Grandma's house,” a geospatial tag, and “Smith family reunion,” as tags 146 associated with the attribute 156 “Grandma,” may search for and/or select content 110 that are associated with the selected tags 146 (i.e., “Grandma,” “Grandma's house,” a geospatial tag, and “Smith family reunion”).

The journal creation module 152 may then create the requested journal 112 and associate the selected content 110 with the journal 112. For example, the journal 112 may comprise a file that contains the selected content 110 (e.g., journalables). Thus, the journal creation module 152 may include functionality to save the selected content 110 to a file in a structured manner, thus creating the journal 112. The journal creation module 152 may assign an identifier such as a name, number, or the like to the journal 112 (e.g., to the file) for storage, categorization, searching for, and/or retrieval of the journal 112. Thus, in the example discussed above, the journal creation module 152 may create a journal 112 that is comprised of a file having the name “Grandma,” which includes various content 110 such as photographs, text files, SMS messages, MMS messages, emails, calendar entries, video, audio, POIs, navigation routes, and so on, stored in a structured manner.

The journal 112 may also comprise a file that contains one or more link(s) 114 to the selected content 110. Thus, the journal creation module 152 may include functionality to create a journal 112 that is comprised of a file containing links 114 to the selected content 110 arranged in a structured manner within the file. The file containing the links 114 may comprise either the entirety or a portion of the selected content 110 in a journal 112. This implementations save available memory by providing access to the content 110 without storing the content 110 within the journal 112. In such implementations, the content 110 may be stored separately from the journal 112, for instance, by the various content sources 108 (including the server 102, client device 104, and/or other client devices 104) in a distributed manner. For example, the content 110 may remain stored by the content sources 108 that originally furnished the content 110 to the server. It is further contemplated that the journal 112 may include combinations of copied content 110 and/or links 114 to content 110 stored in a distributed fashion by one or more of the content sources 108.

After the journal creation module 152 of the server 102 has completed the process of creating the journal 112, it may then cause the journal 112 to be furnished to the journaling module 150 of the client device 104 so that the selected content 110 may be accessed by the user of the client device 104. For example, the journal creation module 152 may cause the journal 112, which may contain selected content 110 and/or links 114 to selected content 110, to be transmitted to the client device 104 where it is stored in memory 122. The journaling module 150, the user interface module 140, and/or one or more application module(s) 142 may be configured to provide functionality to access the content 110 associated with the journal 112.

In some implementations, the journal creation module 152 may cause the journal 112 to be stored in memory 120 of the server 102 and/or by one or more content source(s) 108. Thus, the journal 112 would be accessible by the client device 104 through the network 106.

The journaling module 150 may facilitate the entry of journal creation settings by the user of the client device 104 via the touch screen 134, an I/O device such as a keypad or a microphone, and so on. The journaling module 150 may then provide these settings to the journal creation module 152 to control the amount, subject matter, and types of content 110 to be used when the journal 112 is created. Content 110 are not duplicated until the journal 112 is created (e.g., the process is lightweight to record content). In some implementations, the journaling module 150 may directly create journals without the assistance of the journal creation module 152.

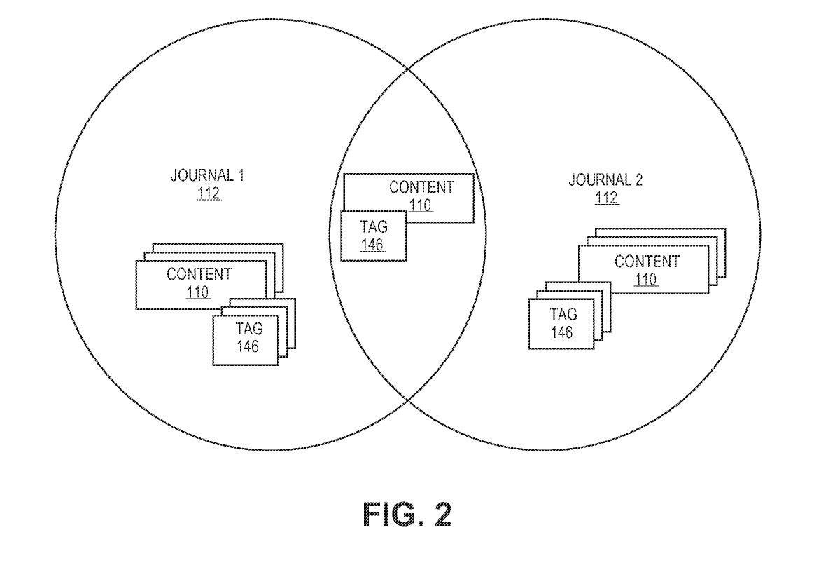

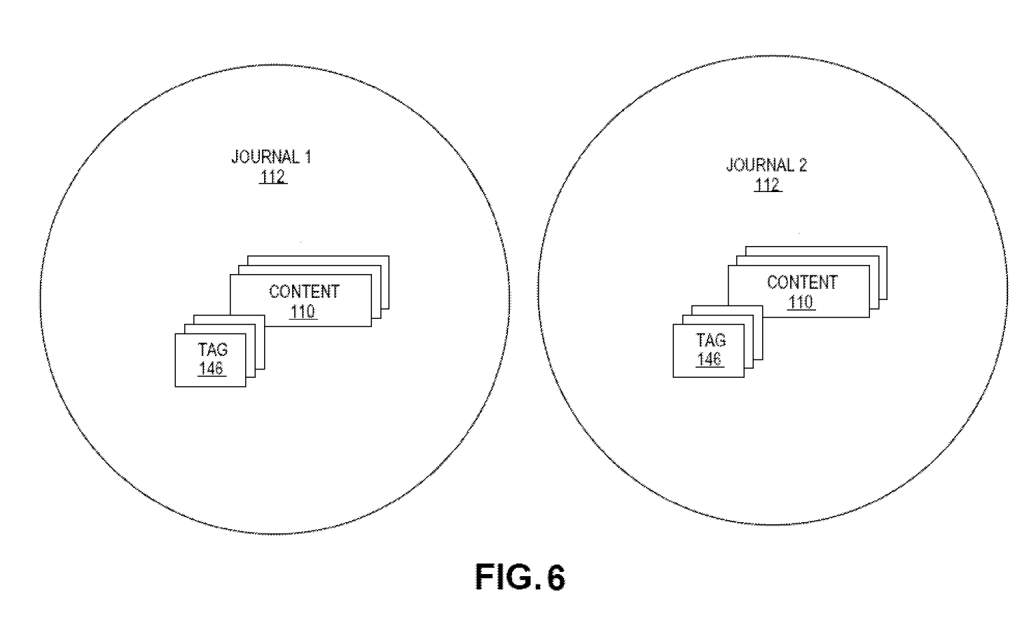

It is contemplated that content 110 may be selected from one or more existing journals 112 by the journaling module 150 and/or the journal creation module 152. The journal creation module 152 may identify an intersection, as illustrated in FIG. 2, between two or more existing journals 112 based on a time-place element, a friend-social network element, confidence level assigned to the content 110, combinations thereof, and the like. In some situations, the journal creation module 152 may identify no intersection, as illustrated in FIG. 6.

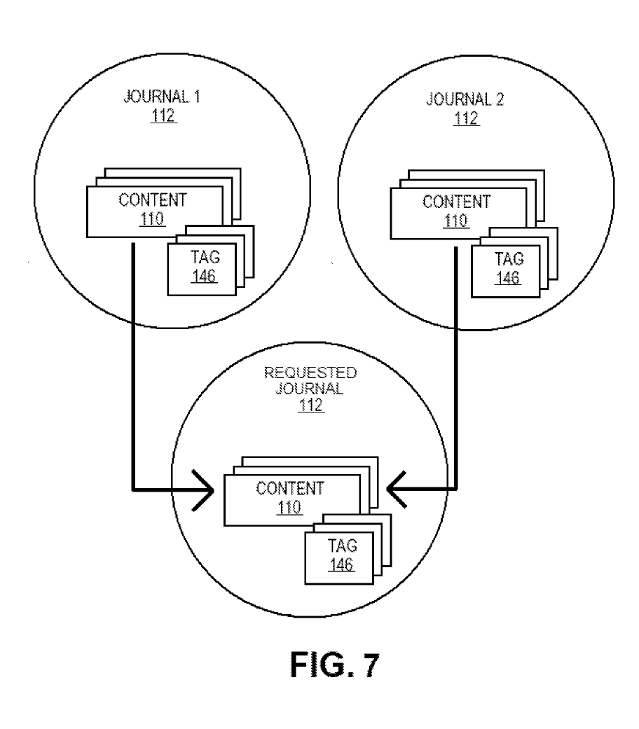

In some implementations, the journal creation module 152 may include functionality to select content 110 for the journal 112 from one or more existing journals 112 that are not identified as having an intersection by the journal creation module 152. In such an implementation, the journal creation module 152 creates a new requested journal 112 with selected content 110 from one or more existing journals 112 that do not intersect. For instance, as illustrated in FIG. 7, the journal creation module 152 may identify two journals, Journal 1 112 and Journal 2 112, before associating content tags 146 with the one or more attributes 156 to ascertain the appropriate tags 146 to be used in selection of content 110 for inclusion into the requested journal 112. Once the tags 146 are selected, the journal creation module 152 may select content 110 from Journal 1 112 and/or Journal 2 112 that includes the selected tags 146 for inclusion into requested journal 112. The journal creation module 152 may, for example, select the tags “Grandma,” “Grandma's house,” a geospatial tag, and “Smith family reunion,” as tags 146 associated with the attribute 156 “Grandma.” The journal creation module 152 may search for and/or select content 110 that include the selected tags 146 (i.e., “Grandma,” “Grandma's house,” a geospatial tag, and “Smith family reunion”) that is associated with one or more existing journals 112. In one example, the selected content 110 may be photographs of Grandma that are associated with one or more existing journals 112 (e.g., journals 112 belonging to separate users labeled “Sister's Wedding” and “Family”). All selected photographs may be associated with the requested journal 112. In another example, the selected content 110 may be videos from the Smith family reunion. The videos may be included in a Journal 1 112 created by a first user (e.g., labeled “Smith Family Reunion”) stored in memory 122 of the first user's client device 104 as well as a Journal 2 112 (e.g., labeled “Family and Friends”) created by a second user and stored by a third party content source 108. All selected videos may be associated with the requested journal 112.

In some implementations, the journal creation module 152 may include functionality to select content 110 for a journal 112 that is related to an intersection between one or more existing journals 112. In such an implementation, the journal creation module 152 creates a new requested journal 112 with selected content 110 common to one or more existing journals 112. Content 110 that is common to one or more existing journals 112 may be distinct and unique. For instance, as illustrated in FIG. 2, the journal creation module 152 identifies two or more existing journals 112 that contain intersecting content 110 by first associating content tags 146 with the one or more attributes 156 to ascertain the appropriate tags 146 to be used in selection of content 110 for inclusion into the requested journal 112. Once the tags 146 are selected, the journal creation module 152 selects content 110 common to the two or more existing journals 112 that include the selected tags 146 for inclusion into requested journal 112.

The journal creation module 152 may identify an intersection between two or more existing journals 112 based on a time-place element and/or a friend-social network element. For instance, in one example, Bob is a friend with Joe, and Joe is a friend with Carl. The journal creation module 152 may identify an intersection between two or more existing journals 112 at least partially based on the friend-social network element. In an implementation, an attribute 156 may be created entitled “Joe's birthday.” A first journal 112 created by Bob may contain tagged content 110 associated with Joe's birthday party (e.g., photographs from Joe's party, SMS messages relating to Joe's party, and so on), and a second journal 112 created by Carl also contains tagged content 110 associated with Joe's birthday party (e.g., photographs from Joe's party, navigation information to the location of Joe's party, and so on). However, both journals 112 may contain content 110 that is not associated with Joe's birthday party. Thus, the journal creation module 152 may select the content 110 related to Joe's birthday party and common to the first and second journals 112 by associating the content tags 146 of the tagged content 110 with the attribute 156.

The journal creation module 152 may also identify an intersection between two or more existing journals 112 that are associated with a social networking site (e.g., FACEBOOK, MYSPACE, BEBO, CollegeBlender, FLICKR, TWITTER, and so on). In an implementation, the journal creation module 152 may identify content 110 that is common to two or more existing journals associated with one or more social networking sites. For instance, a first user may have a tagged video included in the first user's journal 112 on FACEBOOK. A second user may also have the tagged video included in the second user's journal 112 on FACEBOOK. The journal creation module 152 may select the tagged video by identifying a tag 146 associated with the tagged videos and associating the tag 146 with an attribute 156 of the request 154.

The journal creation module 156 may also identify an intersection at least partially based on a time-place element. For example, a user may have taken a trip to the Grand Canyon on Sep. 3, 2010. The journaling module 150 of the client device 104 may generate a request 154 to create a journal 112 containing an attribute 156 entitled “Grand Canyon—Sep. 3, 2010.” The journal creation module 152 ascertains the appropriate tagged content 110 to be used in selection of content 110 by associating content tags 146 with the attribute 156 (“Grand Canyon—Sep. 3, 2010”). The journal creation module 152 may select content 110 that include the selected tags 146 and is common to two or more existing journal(s) 112. For example, the selected content 110 may be related to another individual's (or a group of individuals') trip to the Grand Canyon on Sep. 3, 2010. This content 110 may include photographs and/or video created by the other individuals proximate to the Grand Canyon on Sep. 3, 2010.

The journal creation module 152 may also identify an intersection at least partially based on a confidence level assigned to the content 110. For example, the journal creation module 152 ascertains one or more tags 146 to be used in selection of content 110 by associating content tags 146 with the attribute 156. Once the selected tags 146 have been ascertained, the journal creation module 152 selects content 110 that include the selected tags 146 and a predetermined confidence level assigned to the content 110 that is common to two or more existing journals 112. For example, the journal creation module 152 may select content 110 when the content 110 includes the selected tags 146 and the confidence level assigned to content 110 is “High” as discussed above. The confidence level condition may be predefined by a user manually entering the required confidence level into journaling module 150. The confidence level condition may also be predefined as a default value in the journal creation module 152.

Generally, any of the functions described herein can be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, the module represents executable instructions that perform specified tasks when executed on a processor, such as the processors 116 and 118 of the server 102 and client device 104, respectively, of FIG. 1. The executable program can be stored in one or more computer readable media, an example of which is the memory 120 and 122 of the server 102 and client device 104, respectively, of FIG. 1. The features of the techniques to facilitate the automatic creation of journals described below are platform-independent, meaning that the techniques may be implemented on a variety of commercial computing platforms having a variety of processors.

Example Procedures

The following discussion describes techniques to facilitate the automatic creation of journals. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the example intersection illustrated by the Venn diagram of FIG. 2.

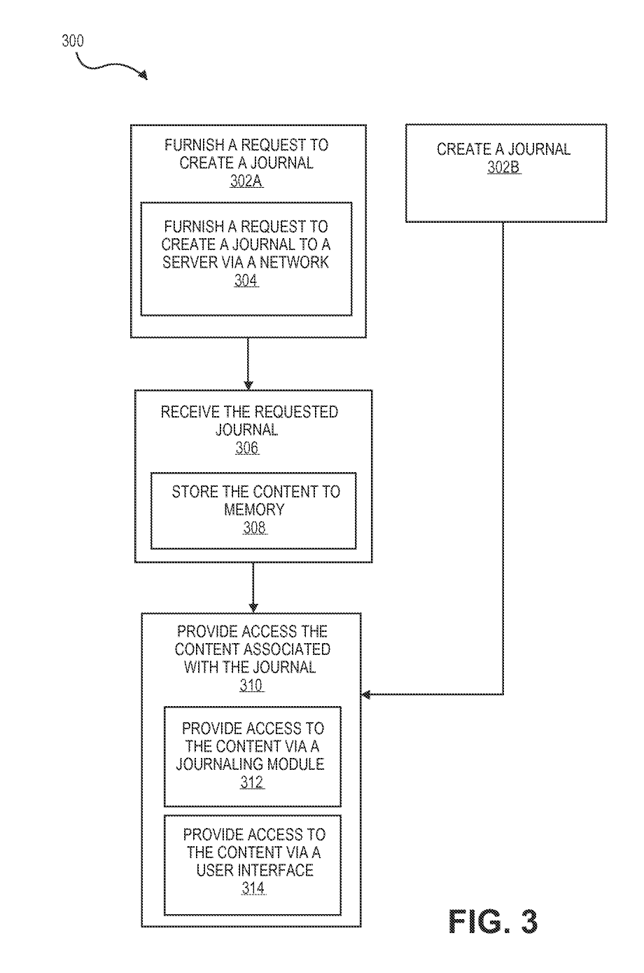

FIG. 3 depicts a procedure 300 in an example implementation in which a client device 104 facilitates the creation of a journal 112 and thereafter provides access to the journal 112 created by the server 102 and/or client device 104. As illustrated, a user employs the client device 104 to cause a journal 112 to be created (block 302a). For example, the user may employ the client device 104 illustrated in FIG. 1 to generate a request 154 to create a journal 112. The user may generate the request 154 via the touch screen 134, an I/O device such as a keypad or a microphone, and so on. In an implementation, a journaling module 150 residing on client device 104 may furnish the request 154 to a journal creation module 152 residing on server 102 via a network 106 (block 304). An implementation of the server 102 response to the request 154 is described below. The requested journal is then received (block 306). As shown in FIG. 1, the journaling module 150 receives the requested journal 112 from journal creation module 152. The requested journal 112 is then stored into memory 122 (block 308).

In another example, the user may employ the client device 104 to cause a journal 112 to be created (block 302b). For example, the journaling module 150 illustrated in FIG. 1 may automatically create one or more journal(s) 112 that include content 110 selected from the content 110 resident within the memory 122 that has been tagged by the content tagging module 144.

Access may then be provided to the content 110 associated with the requested journal 112 (block 310). In an implementation, the journaling module 150 may provide access to the contents 110 associated with the requested journal 112. For example, a user of client device 104 may access the requested journal 112 via the journaling module 150 (block 312). In another example, the user of client device 104 may access the requested journal 112 via a user interface module 140 (block 314). In yet another example, the user of client device 104 may access the requested journal 112 via one or more application modules 142.

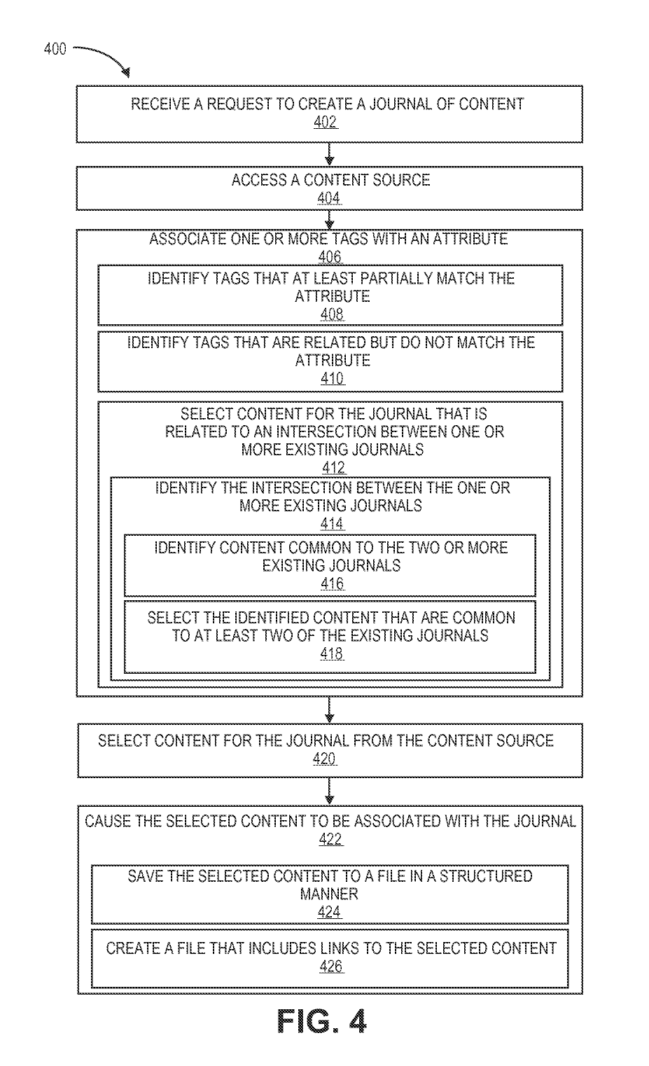

FIG. 4 depicts a procedure 400 in an example implementation in which content 110 is selected for inclusion into a requested journal 112. As illustrated, a request 154 to create a journal 112 of content 110 is received from a client device 104 (block 402). For example, as shown in FIG. 1, the journaling module 150 of the client device 104 may generate a request 154, which includes one or more attributes 156, to create a journal 112. The server 102 illustrated in FIG. 1 is configured to receive the request 154 from the journaling module 150. In some examples, where the journal 112 is created by the client device 104, the journaling module 150 of the client device 104 may generate and fill the request 154 to create a journal 112 without assistance from a server 102.

Next, a content source 108 is accessed (block 404). The one or more attribute(s) 156 is/are associated with content tags 146 (block 406). It is to be understood that while the process of searching tags 146 is illustrated in one or more implementations, searching can also be based on searchable content within the content 110 itself using text, recognizable images, video, biometric and cardiovascular information content, names of journals, vehicle information content, navigation information content, etc. Navigation information content comprises any information that may be used to determine or plan the location-based services. For instance, navigation information may include, but is not limited to, geo-coordinates, geographical data, map data, routes, waypoints, points of interest, points of interest searches, departure times, and arrival times.

In an implementation, the journal creation module 152 associates content tags 146 with the one or more attribute(s) 156 to ascertain the appropriate tags 146 to be used in the selection of content 110. For example, the journal creation module 146 may select tags that at least partially match the one or more attribute(s) identified in the request 154 (block 408). For instance, the journal creation module 152 may select the tags containing the text “Grandma” and “Grandma's House” as being associated with the attribute 156 “Grandma” in a request 154. In another example, the journal creation module 152 may select tags 146 that are related to but do not match the one or more attributes 156 in the request 154 (block 410). For instance, the journal creation module 152 may select geospatial tags 146 comprised of a latitude, longitude, and/or altitude that at least approximately match the location of the home of the grandmother of the user of the client device 104 as being associated with the attribute 156 “Grandma” described above. In yet another example, content 110 may be selected that is related to an intersection between one or more existing journals 112 (block 412). For example, as shown in FIG. 2, the journal creation module 152 may identify an intersection between the one or more existing journal(s) 112 (block 414). The journal creation module 152 may further identify the intersection by identifying content 110 common to two or more existing journals 112 (block 416). The identified content 110 common to the two or more existing journals 112 is/are selected for inclusion into the requested journal 112 (block 418)

The content 110 is/are selected from the content source 108 for inclusion into the journal 112 (block 420). For example, as shown in FIG. 1, the journal creation module 152 may select content 110 from the various content sources 108 that include the selected tags 146. For instance, the journal creation module 152, having selected the tags 146 “Grandma,” Grandma's house,” a geospatial tag, and “Smith family reunion,” as tags 146 associated with the attribute 156 “Grandma,” may search for and/or select content 110 that is/are associated with the selected tags 146.

Next, the selected content 110 is/are associated with the requested journal 112 (block 422). In one example, the journal creation module 152 may associate content 110 with the requested journal 112 by saving the selected content 110 to a file in a structured manner (block 424). In another example, as shown in FIG. 1, the journal creation module 152 may associate content 110 with the requested journal 112 by creating a file that includes one or more link(s) 114 to the selected content 110 (block 426). For instance, the content 110 may be stored separately from the journal 112 in various content sources 108 (e.g., the server 102, the client device 104, and/or other client devices 104) in a distributed manner. The user of client device 104 may access the selected content 110 by selecting (e.g., clicking, etc.) the appropriate link 114 associated with the selected content 110. In some examples, the content 110 may be associated with the requested journal by using a combination of saving selected content 110 directly to a file and creating a file that includes one or more links 114 to selected content 110 that is stored separately. Thus, content 110 associated with the journal 112 may be presented to the user in any format using the display 132, the I/O devices 136, the user interface module 140, combinations thereof, and the like.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method for creating a journal, the method comprising:
receiving a request from a client device through a network to create a journal of content, the request including an attribute relating to the content of the journal;
accessing a computer-readable content source with a processor, the content source comprising one or more existing journals including content having tags describing the content;
associating one or more of the tags of the one or more existing journals with the attribute using the processor; and
creating the journal using the processor by causing content from the one or more existing journals to be associated with the journal, the associated content having tags associated with the attribute.

2. The method as recited in claim 1, wherein associating one or more tags with the attribute comprises identifying tags at least partially matching the attribute.

3. The method as recited in claim 1, wherein associating one or more tags with the attribute comprises identifying tags related to, but not at least partially matching, the attribute.

4. The method as recited as claim 1, wherein causing content to be associated with the journal comprises storing the associated content in a computer-readable medium.

5. The method as recited as claim 1, wherein causing content to be associated with the journal comprises making the content accessible using links to the content.

6. The method as recited in claim 1, wherein associating one or more of the tags with the attribute comprises:
identifying tags that at least partially match the attribute;
identifying tags that are related to but do not at least partially match the attribute; and
selecting the identified tags to be associated with the attribute.

7. The method as recited in claim 5, wherein the selecting of identified tags to be associated with the attribute comprises selecting content related to the identified tags.

8. The method as recited in claim 1, wherein the tags comprise a geospatial tag configured to associate a location with the content.

9. The method as recited in claim 1, wherein the tags comprise a temporal tag configured to associate a time with the content.

10. The method of claim 1, further including transmitting the journal and associated content to the client device for display by the client device to a user.

11. The method of claim 1, further including displaying the journal and the associated content.

12. A system comprising a server operable to create a journal in response to a request received from a client device, the request including an attribute relating to the content of the journal, the server operable to:
access a content source comprising one or more existing journals including content having tags describing the content,
associate one or more of the tags of the one or more existing journals with the attribute, and
create the journal by causing content from the one or more existing journals to be associated with the journal, the associated content having tags associated with the attribute.

13. The system as recited in claim 12, wherein the server is operable to associate one or more tags with an attribute by identifying tags at least partially matching the attribute.

14. The system as recited in claim 12, wherein the server is operable to associate one or more tags with an attribute by identifying tags related to, but not at least partially matching, the attribute.

15. The system as recited in claim 12, wherein the server is operable to cause content to be associated with the journal by storing the content within the journal.

16. The system as recited in claim 12, wherein the server is operable to cause content to be associated with the journal by making the content accessible using links to the content.

17. The system as recited in claim 12, wherein the server is further operable to:
identify tags that at least partially match the attribute;
identify tags that are related to but do not at least partially match the attribute; and
select the identified tags to be associated with the attribute.

18. The system as recited in claim 17, wherein the tags comprise a geospatial tag configured to associate a location with the content.

19. The system as recited in claim 17, wherein the tags comprise a temporal tag configured to associate a time with the content.

20. A system for creating a journal, the system comprising:
a client device operable to:
create a request including an attribute relating to the content of the journal; and
provide the request through a network; and
a server operable to:
receive the request through the network;
access a content source comprising one or more existing journals including content having tags describing the content;
associate one or more of the tags of the one or more existing journals with the attribute; and
create the journal by causing content from the one or more existing journals to be associated with the journal, the associated content having tags associated with the attribute.
